(19) United States
(12) Patent Application Publication
(10) Pub. No.: US 2024/0301219 A1
(43) Pub. Date: Sep. 12, 2024

(54) FLAME-RETARDANT POLYMER COMPOSITION

(71) Applicant: IMERYS USA, INC., Roswell, GA (US)

(72) Inventors: Maziyar Bolourchi, Cumming, GA (US); Saied Kochesfahani, Suwanee, GA (US)

(21) Appl. No.: 18/289,256

(22) PCT Filed: Jun. 9, 2022
(86) PCT No.: PCT/US22/32846

§ 371 Date: Nov. 2, 2023

Related U.S. Application Data
(60) Provisional application No. 63/209,535, filed on Jun. 11, 2021.

(51) Int. Cl. C09D 5/18; C08K 3/34; C08K 5/5313; C08K 9/00; C08K 13/06; C09D 7/40; C09D 7/62; C09D 7/63; C09D 177/00

(52) U.S. Cl. CPC C09D 5/18; C09D 7/62; C09D 7/63; C09D 7/70; C09D 177/00; C08K 2003/343; C08K 3/346; C08K 5/5313; C08K 9/00; C08K 13/06

(57) ABSTRACT

A flame-retardant polymer composition comprising a polymer, a flame retardant, metakaolin and optionally a reinforcing material, articles made from and comprising said flame-retardant polymer composition and methods of making said flame-retardant polymer composition.

### TECHNICAL FIELD

The present invention further relates to articles comprising or made from flame-retardant polymer compositions and methods of making said flame-retardant polymer compositions and articles.

### BACKGROUND

Flame retardant polymer compositions are widely used especially in places where high temperatures and/or fire hazards are present, or where the burn result of the polymer composition is a catastrophe. For example, flame retardant polymers can be used in an electrical cable sheath to limit the risk of electrical system failure in the event of a fire and to limit the risk of fire starting or spreading as a result of cable overheating due to current. Further, flame retardant paints can be used as a passive fire resistance measure to protect structures.

Intumescent flame-retardant polymer compositions are ones that swell as a result of heat exposure, thus leading to an increase in volume and decrease in density. The key feature of intumescent flame-retardant polymer compositions is that they expand significantly when exposed to high temperatures, such as those found in a fire. Some intumescent products can expand to more than 100-times the original thickness. As the product expands it becomes much less dense, which makes it act as an insulator to limit the spreading of a fire.

Unfortunately, intumescent flame-retardant formulations can suffer from melt stability issues and can enhance corrosivity towards steel used in processing equipment. Thus, it is desirable to provide alternative and/or improved intumescent flame-retardant formulations which overcome these issues but still meet requirements, such as UL94 Flame Retardant ratings, total flame time, viscosity, mechanical properties (including stiffness and tensile strength), and others.

### SUMMARY

In accordance with a first aspect of the present invention there is provided a flame-retardant polymer composition comprising a polymer, a flame retardant, and metakaolin, wherein when the flame-retardant polymer is formed into a layer having a thickness less than or equal to about ⅛ inch, and greater than or equal to about 1/128 inch, the flame-retardant rating for the composition is V0 as determined by the United Laboratories Standard test 94, edition 6. Further, in aspects, when the flame-retardant polymer is formed into a layer having a thickness of less than or equal to about 1/16 inch and greater than or equal to about 1/64 inch, the flame-retardant rating for the composition is V0 as determined by the United Laboratories Standard test 94, edition 6. In aspects, when the flame-retardant polymer is formed into a layer having a thickness of less than or equal to about 1/32 inch and greater than or equal to about 1/64 inch, the flame-retardant rating for the composition is V0 as determined by the United Laboratories Standard test 94, edition 6.

In the above aspects, the metakaolin can have a shape factor of less than 20, and optionally no greater than 10, or no greater than 8, or no greater than 5.

In the above aspects, the metakaolin can have a soluble alumina content of from about 10 wt % to about 30 wt % by weight of the metakaolin, and optionally from about 14 wt % to about 28 wt %, or about 18 wt % to about 26 wt %, or about 20 wt % to about 26 wt % by weight of the metakaolin. The specified soluble alumina content can be in combination or separate from the specified shape factor.

In the above aspects, the polymer can be a polyamide. Also, the aspects can use an intumescent flame retardant, which optionally can be an organic phosphinate.

In the aspects, the flame retardant can be present in an amount greater than about 10 or 12 or 13 or 14 or 15 wt % and less than or equal to 20 or 18 or 17.5 or 16.5 or 16 wt % based on the total weight of the flame-retardant polymer composition. The metakaolin can be in an amount of at least about 1 or 3 or 5 or 7 wt % and less than or equal to 20 or 15 or 12 or 10 or 8 wt % based on the total weight of the flame-retardant polymer composition.

The flame-retardant polymer compositions as described above can have a total flame time, when formed into a layer having a thickness less than or equal to about 1/32 inch and greater than or equal to about 1/64 inch, of less than 50 seconds, or more typically less than 40 seconds, or less than 30 seconds, or for a thickness of about 1/64 inch, is less than 50 seconds or more typically less than 40 seconds, as determined by the United Laboratories Standard test 94, edition 6.

The flame-retardant polymer compositions as described can have an average molecular weight of at least 3%, or optionally, at least 5% or at least about 10% or at least about 15% or at least about 20% or at least about 30% or at least about 40%, greater than the average molecular weight of a flame-retardant polymer composition which is identical except comprising the same amount of a different mineral additive or reinforcing additive, other than metakaolin.

The flame-retardant polymer composition as described can have an intrinsic viscosity of at least 3 ml/g, or optionally at least 4 ml/g or at least about 5 ml/g or at least about 7 ml/g, greater than the intrinsic viscosity number of a flame retardant-polymer composition which is identical except comprising the same amount of a different mineral additive or reinforcing additive, other than metakaolin.

The flame-retardant polymer composition as described can have an improved corrosion resistance when compared to a flame-retardant polymer composition that is identical except comprising the same amount of a different mineral additive or reinforcing additive, other than metakaolin.

In aspects, all the flame-retardant polymer compositions described can include a reinforcing additive present in an amount of from about 10 wt % to about 40 wt %. For these aspects, the combined amount of metakaolin and reinforcing additive in the composition can be up to 20 wt %, or 30 wt %, or 40 wt % or 50 wt % based on the total weight of the composition. The reinforcing additive in some of these aspects will be selected from glass fibers, wollastonite, talc, mica, magnesium oxysulphate, carbon fiber, hydrous kaolin having a shape factor of more than 20 (or optionally of 60 or more), calcined kaolin, and combinations thereof.

In other aspects, there is an article comprising a substrate material and a flame-retardant polymer composition as described above. For example, the substrate material can be an electric cable, electrical or electronic part, or a car part and the substrate material is made if or covered with the flame-retardant polymer composition.

For example, the flame-retardant polymer compositions coated on the substrate comprise a polymer, a flame retardant, and metakaolin, and the flame-retardant polymer composition can be coated on the substrate to form a layer. When the flame-retardant polymer is formed into a layer having a thickness less than or equal to about ⅛ inch, and greater than or equal to about 1/128 inch, the flame-retardant rating is V0 as determined by the United Laboratories Standard test 94, edition 6. When the flame-retardant polymer is formed into a layer having a thickness of less than or equal to about 1/16 inch and greater than or equal to about 1/64 inch, the flame-retardant rating is V0 as determined by the United Laboratories Standard test 94, edition 6. When the flame-retardant polymer is formed into a layer having a thickness of less than or equal to about 1/32 inch and greater than or equal to about 1/64 inch, the flame-retardant rating for the composition is V0 as determined by the United Laboratories Standard test 94, edition 6.

For example, the metakaolin used in the flame-retardant polymer composition of the article can have a shape factor of less than 20, and optionally no greater than 10, or no greater than 8, or no greater than 5. In addition to or separate from the shape factor, the metakaolin can have a soluble alumina content of from about 10 wt % to about 30 wt % by weight of the metakaolin, and optionally from about 14 wt % to about 28 wt %, or about 18 wt % to about 26 wt %, or about 20 wt % to about 26 wt % by weight of the metakaolin.

For example, the polymer can be a polyamide and/or the flame retardant can be an intumescent flame retardant, which optionally can be an organic phosphinate. Further, the flame retardant can be present in an amount greater than about 10 or 12 or 13 or 14 or 15 wt % and less than or equal to 20 or 18 or 17.5 or 16.5 or 16 wt % based on the total weight of the flame-retardant polymer composition. The metakaolin can be in an amount of at least about 1 or 3 or 5 or 7 wt % and less than or equal to 20 or 15 or 12 or 10 or 8 wt % based on the total weight of the flame-retardant polymer composition.

For example, when the flame-retardant polymer composition is coated on the article, the total flame time, when formed into a layer having a thickness less than or equal to about 1/32 inch and greater than or equal to about 1/64 inch, can be less than 50 seconds, or more typically less than 40 seconds, or less than 30 seconds, or for a thickness of about 1/64 inch, can be less than 50 seconds or more typically less than 40 seconds, as determined by the United Laboratories Standard test 94, edition 6.

For example, the flame-retardant polymer compositions as described can have an average molecular weight of at least 3%, or optionally, at least 5% or at least about 10% or at least about 15% or at least about 20% or at least about 30% or at least about 40%, greater than the average molecular weight of a flame-retardant polymer composition which is identical except comprising the same amount of a different mineral additive or reinforcing additive, other than metakaolin.

For example, the flame-retardant polymer composition as described can have an intrinsic viscosity of at least 3 ml/g, or optionally at least 4 ml/g or at least about 5 ml/g or at least about 7 ml/g, greater than the intrinsic viscosity number of a flame retardant-polymer composition which is identical except comprising the same amount of a different mineral additive or reinforcing additive, other than metakaolin.

For example, the article incorporating the flame-retardant polymer composition can have an improved corrosion resistance when compared to a flame-retardant polymer composition that is identical except comprising the same amount of a different mineral additive or reinforcing additive, other than metakaolin.

In the articles described, the flame-retardant polymer compositions can include a reinforcing additive present in an amount of from about 10 wt % to about 40 wt %. For these aspects, the combined amount of metakaolin and reinforcing additive in the composition can be up to 20 wt %, or 30 wt %, or 40 wt % or 50 wt % based on the total weight of the composition. The reinforcing additive in some of these aspects will be selected from glass fibers, wollastonite, talc, mica, magnesium oxysulphate, carbon fiber, hydrous kaolin having a shape factor of more than 20 (or optionally of 60 or more), calcined kaolin, and combinations thereof.

### BRIEF DESCRIPTION OF THE FIGURES

Aspects and various aspects of the present disclosure are illustrated in the following detailed description and accompanying figures.

FIG. 1 is a graph illustrating the Flexural Modulus of various compositions as defined in Example 1.

FIG. 2 is a graph illustrating the Flexural Strength of various compositions as defined in Example 1.

FIG. 3 is a graph illustrating the Notched Izod Impact at 23° C. of various compositions as defined in Example 1.

FIG. 4 is a graph illustrating the Tensile Modulus of various compositions as defined in Example 1.

FIG. 5 is a graph illustrating the Tensile Strength of various compositions as defined in Example 1.

FIG. 6 is a graph illustrating the Tensile Elongation of various compositions as defined in Example 1.

FIG. 7 is a graph illustrating the UL94 FR Rating of various compositions as defined in Example 1.

FIG. 8 is a graph illustrating the UL94 FR—Total Flame Time of various compositions as defined in Example 1.

FIG. 9 includes photos showing a visual comparison of corrosion effects for various formulations as defined in Example 2.

### DETAILED DESCRIPTION

Particular aspects of the present invention and/or disclosure are described in greater detail below. The terms and definitions provided herein control, if in conflict with terms and/or definitions incorporated by reference.

As used herein, the terms “comprises,” “comprising;” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.”

As used herein, the singular forms “a,” “an,” and “the” include plural reference unless the context dictates otherwise. The terms “approximately” and “about” refer to being nearly the same as a referenced number or value. As used herein, the terms “approximately” and “about” should be understood to encompass ±5% of a specified amount or value.

There is disclosed herein a flame-retardant polymer composition comprising a polymer, a flame retardant, metakaolin and optionally, a reinforcing additive. The flame-retardant polymer composition can, for example, consist of or consist essentially of a polymer, a flame retardant, metakaolin and, optionally, a reinforcing additive. The term “consisting essentially of” excludes an additional element, step or ingredient not explicitly recited unless the additional element, step or ingredient does not materially affect the basic and novel properties of the invention. For example, “consisting essentially of” would not exclude trace amounts of materials that do not affect the properties of the claimed compound.

Each of the components of the flame-retardant polymer composition disclosed herein may be present in any amount within the ranges specified herein provided that the total wt % of the flame-retardant polymer composition is 100 wt %.

The polymer may, for example, be a thermoplastic polymer. The polymer may, for example, be present in the form of a polymer matrix. The other components of the flame-retardant polymer composition (e.g. the flame retardant, the high aspect ratio particulate mineral, the optional reinforcing additive) are dispersed in the polymer matrix. The polymer, for example, can be a thermoplastic olefin, polyamide (including, but not limited to, nylon PA6, nylon 66, nylon 46, nylon 4T, nylon 6T, nylon 6/10, nylon 9T, nylon 10T, nylon 11T and nylon 12), polyester (including, but not limited to, polycarbonate, polyethylene terephthalate, polybutylene terephthalate, polylactic acid, and polybutylene succinate), acrylonitrile butadiene styrene (ABS), polymethyl methacrylate (PMMA), thermoplastic elastomer (TPE), thermoplastic polyurethane (TPU), polyphthalamide (PPA), polyoxymethylene (POM), polyvinyl chloride (PVC), polystyrene (PS), polyphenylene ether (PPE—also known as polyphenylene oxide (PPO)) and blends thereof. The polymer may, for example, be polyalkylene (e.g. polyethylene, polypropylene or polybutylene), polyvinyl ester (general formula —[RCOOCHCH₂]—), polystyrene, polyvinyl chloride, polyvinyl acetate, polyvinyl alcohol, polyacrylonitrile, acrylonitrile butadiene styrene, polyamide, polylactic acid, polybutylene terephthalate, polyethylene terephthalate, polycarbonate, polyvinyl acetate (e.g. ethylene vinyl acetate or poly(meth methacrylate)), or a combination of two or more thereof. In certain aspects, the polymer is one or more polyamide(s).

Broadly, the polymer can be present in the flame-retardant polymer composition in an amount of from about 30 wt % to about 80 wt % based on the total weight of the flame-retardant polymer composition. More typically, the polymer can be present in the flame-retardant polymer composition in an amount of at least about 35 wt % or at least about 40 wt % or at least about 55 wt % based on the total weight of the flame-retardant polymer composition. Additionally, more typically, the polymer can be present in the flame-retardant polymer composition in an amount up to about 75 wt % or up to about 70 wt % or up to about 65 wt % or up to 60 wt % or up to 55 wt % or up to 50 wt % based on the total weight of the flame-retardant polymer composition. As will be realized, the range of the amount of polymer in the flame-retardant polymer composition can be any combination of the lower limits with the upper limits, for example, be present in the flame-retardant polymer composition in an amount ranging from about 40 wt % to about 80 wt % or from about 40 wt % to about 50 wt %, etc. based on the total weight of the flame-retardant polymer composition.

The term “flame retardant” refers to any chemical that, when added to a polymer, can prevent fire, inhibit or delay the spread of fire and/or limit the damage caused by fire. The flame retardant may, for example, work by one or more of endothermic degradation, thermal shielding, dilution of gas phase and gas phase radical quenching. Flame retardants that work by endothermic degradation remove heat from the substrate and thus cool the material. Flame retardants that work by thermal shielding create a thermal insulation barrier between the burning and unburned parts of the material, for example by forming a char, which separates the flame from the material and slows heat transfer to the unburned material. Flame retardants that work by dilution of the gas phase produce inert gases (e.g. carbon dioxide and/or water) by thermal degradation and thus dilute the combustible gases, thus lowering the partial pressures of the combustible gases and oxygen and slowing the reaction rate. Flame retardants that work by gas phase radical quenching release substances such as hydrogen chloride and hydrogen bromide that react with H and OH radicals in the flame, forming less reactive radicals (e.g. CI and Br radicals), which have much lower potential to propagate the radical oxidation reactions. In certain aspects, the flame retardant used in the flame-retardant polymer compositions disclosed herein is an intumescent flame retardant. This refers to any flame retardant that can swell as a result of heat exposure, thus increasing its volume and decreasing its density. The intumescent flame retardant may produce char upon combustion which can act as a thermal insulation barrier between the burning and unburned materials.

While the current benefits may be achieved with compositions using other flame retardants, typically the compositions hereunder will use intumescent flame retardants. More typically, the compositions hereunder will use organo phosphinate flame retardants.

The flame retardants hereunder can be halogenated or non-halogenated compositions. For example, the flame retardant can be halogenated compositions such as tetrabromobisphenol A (TBBA), dodecahlorepentacyclooctadecadiene (Dechlorane), decabromodiphenylether (Deca), hexabromocyclododecane (HBCD), tetrabromophthalic acid anhydride and synergist (Antimony Trioxide) and combinations thereof. For example, the flame retardant can be non-halogenated compositions such as polyphosphate, phosphinic acid derivatives, red phosphorous, ammonium polyphosphate (APP) and triarylphosphates, melamine cyanurate, melamine polyphosphate, magnesium hydroxide and aluminum hydroxide and combinations thereof

Intumescent flame retardants useful in the composition may be phosphorous and/or nitrogen-containing compounds; for example, red phosphorus, a phosphate, a polyphosphate (e.g. melamine polyphosphate), a phosphonate (e.g. dimethyl methylphosphonate (DMMP), a phosphinate (e.g. aluminium diethyl phosphinate), a halogenated organophosphate (e.g. tris(1,3-dichloro-2-propyi)phosphate, tetrakis(2-chlorethyl)dichloroisoentyldiphosphate), a phosphazene, a polyphosphazene, a triazine (e.g. melamine-cyanurate), an organophosphate (e.g. triphenyl phosphate (TPP), resorcinol bis(diphenylphosphate) (RDP), bisphenol A diphenyl phosphate (BADP), tricresyl phosphate (TCP)), or a combination of one or more thereof. In certain aspects, the phosphorous-containing compound is an organophosphate, an organic phosphinate, a halogenated organophosphate or a combination of one or more thereof.

The flame retardant may, for example, be present in the flame-retardant polymer composition in an amount of at least about 10 wt % based on the total weight of the flame-retardant polymer composition. For example, the flame retardant may be present in the flame-retardant polymer composition in an amount of at least about 10 wt %, or at least about 12 wt %, or at least about 13 wt %, or at least about 14 wt %, or at least about 15 wt %, or at least about 16 wt % based on the total weight of the flame-retardant polymer composition.

The flame retardant may be present in the flame-retardant polymer composition in an amount up to about 40 wt %, but more typically is present in an amount up to 20 wt %, based on the total weight of the flame-retardant polymer composition. For example, the flame retardant may be present in the flame-retardant polymer composition in an amount up to about 20 wt %, or up to about 18 wt %, or up to about 17.5 wt %, or up to about 16.5 wt %, or up to about 16 wt % based on the total weight of the flame-retardant polymer composition.

The flame-retardant polymer composition herein includes metakaolin. Metakaolin can be produced from kaolin (Al₂Si₂O₅(OH)₄), which is referred to herein after as hydrous kaolin. Hydrous kaolin includes the minerals kaolinite, dickite, nacrite and halloysite. Hydrous kaolin clay may be a processed material derived from a natural source, namely raw natural kaolin clay mineral. The processed kaolin clay may typically contain at least about 50% by weight kaolinite. For example, most commercially processed kaolin clays contain greater than about 75% by weight kaolinite and may contain greater than about 90% by weight, in some cases greater than about 95% by weight of kaolinite.

The methods of making metakaolin may comprise calcining hydrous kaolin (typically in the form of a kaolin clay) at a suitable temperature and for an appropriate amount of time. The temperature and time may be sufficient to remove some of the water content from kaolin. In some examples, the method of making metakaolin may comprise calcining kaolin at a temperature ranging from about 500° C. to about 900° C., e.g., from about 550° C. to about 850° C., from about 600° C. to about 800° C., from about 650° C. to about 750° C., or from about 680° C. to about 720° C. In some examples, the method of making metakaolin may comprise calcining kaolin for a time ranging from about 30 minutes to about 120 minutes, from about 40 minutes to about 110 minutes, from about 50 minutes to about 100 minutes, from about 60 minutes to about 90 minutes, from about 50 minutes to about 70 minutes, or from about 80 minutes to about 110 minutes. Such conditions may produce metakaolin having a shape factor of no greater than 50 and a soluble alumina content from about 10 wt % to about 30 wt % by weight, relative to the total weight of the metakaolin. However, more typically, such conditions can be used to produce a metakaolin having a shape factor of less than 20, or of no more than about 10, or of no more than about 8, or of no more than about 5. Also, such conditions can be used to produce a metakaolin having any of the forgoing shape factors and a soluble alumina content of from about 10% to about 30%, or from about 14 wt % to about 30 wt %, 14 wt % to about 28 wt %, or from about 18 wt % to about 30 wt %, or from 18 wt % to 28 wt % or from about 18 wt % to about 26 wt %, or from about 20 wt % to about 26 wt % by weight relative to the total weight of the metakaolin. Both shape factor and soluble alumina content are further discussed below.

Calcining hydrous kaolin at temperatures above 900° C., and perhaps for longer times (>120 minutes) at temperatures lower than 900° C., produces what can be referred to as “calcined kaolin” or “spinel kaolin”. Basically, the additional heating causes a conversion to an aluminum-silicon spinel, which is sometimes referred to as a gamma-alumina type structure. Further, heating at even higher temperatures can cause the spinel phase to nucleate and transforms to platelet mullite and highly crystalline cristobalite. This nucleated phase is also included herein under the term “calcined kaolin”. Metakaolin, though calcined, is not included in the term “calcined kaolin”.

As will be appreciated, metakaolin is a different phase from either hydrous kaolin or calcined kaolin. For example, metakaolin has a different shape factor and higher soluble alumina content than the hydrous kaolin, and has a higher soluble alumina content from calcined kaolin.

As used herein, the term “shape factor” refers to a measure of an average value (on a weight average basis) of the ratio of mean particle diameter to particle thickness for a population of particles of varying size and shape. Shape factor may be measured using the electrical conductivity method and apparatus described in U.S. Pat. No. 5,576,617 (also referred to as PANACEA (particle assessment [by] natural alignment [and] conductivity effect analysis)). In this method, the electrical conductivity of a fully dispersed aqueous suspension of the particles is measured as they flow through an elongated tube.

Measurements of the electrical conductivity are taken between (a) a pair of electrodes separated from one another along the longitudinal axis of the tube, and (b) a pair of electrodes separated from one another across the transverse width of the tube. The shape factor of the particulate material is determined from the difference between these two conductivity measurements. Higher shape factors generally describe more platy materials.

The metakaolin herein will have a shape factor that is less than the hydrous kaolin from which it is formed. Typically, the metakaolin herein can have a shape factor of less than about 20. However, in more typical aspects the metakaolin has a shape factor no greater than 10 and can have a shape factor of no greater than 8, or no greater than 5. Generally, the lower limit of the shape factor need not be mentioned, but for completeness, the metakaolin can have a shape factor of at least 1. Metakaolin is not generally considered a high aspect ratio or high shape factor material; on the other hand, the platy hydrous kaolin can take the form of what is considered a high aspect ratio or high shape factor material.

While the use of metakaolin has advantages over the use of other mineral additives (for example, hydrotalcite, wollastonite, mica, talc, hydrous kaolin, and/or calcined kaolin), there are particular advantages over the use of such other mineral additives having a high aspect ratio, such as hydrous kaolin having shape factor of above 20, and more typically of 60 or more.

The soluble alumina content is an indication of the reactivity of a material. The current disclosure recognizes the discovery that materials with a higher soluble alumina content result in different properties from materials with a lower soluble alumina content when used in a flame-retardant polymer composition.

The amount of soluble alumina content may be measured using nitric acid. In an exemplary method, 100 milligrams of a sample is measured using an analytical balance and transferred to a 16 mm×150 mm test tube with a screw-on cap. 10 mL of concentrated nitric acid is added to the test tube, which is capped loosely. The test tube is then heated in a water bath (with a temperature of 100° C.±2° C.) for 4 hours and allowed to cool down. The top part of the test tube is filled with deionized water and the solution in the test tube is then filtered through ashless filter paper into a 100 mL volumetric flask. A control sample is also prepared using concentrated nitric acid. The flask is then filled to the 100 mL mark and the solution is analyzed by inductively coupled plasma atomic emission spectroscopy (ICP-AES), using various dilution of a 1000 ppm aluminum standard solution as standards. The soluble alumina content is then calculated using the following equation:

$$\% Soluble Alumina = \frac{ppm aluminum \times dilution factor \times 1.88956}{mass of the sample ( grams ) \times 100}$$

The metakaolin used in the current composition generally has a soluble alumina content that is at least about 10% by weight relative to the total weight of the metakaolin. In some aspects the soluble alumina content is at least about 12%, or at least about 14%, or at least about 16%, or at least about 18% by weight relative to the total weight of the metakaolin. Generally, the soluble alumina content will be at most 30% but can be at most 28%, or at most 26%, or at most 24% by weight relative to the total weight of the metakaolin. For example, the soluble alumina content ranges from about 10% to about 30% by weight, or from about 114% to about 30%, about 14% to about 28%, or from about 18% to about 30%, or from 18% to 28% or from about 18% to about 26%, or from about 20% to about 26% by weight relative to the total weight of the metakaolin.

For comparison, typically hydrous kaolin and calcined kaolin would comprise less than 10 wt %, with typical amounts being from about 0.5 wt % to 6 wt % of soluble alumina content relative to the total hydrous kaolin or calcined kaolin. Accordingly, as will be realized, metakaolin differs distinctly from either hydrous kaolin or calcined kaolin. While the aspects of this disclosure encompass adding hydrous kaolin or calcined kaolin to the flame-retardant polymer composition, the aspects require that metakaolin be present. Thus, any hydrous kaolin or calcined kaolin is in addition to metakaolin and not in place of metakaolin in the flame-retardant polymer composition disclosed herein.

According to some aspects of the present disclosure, the flame-retardant composition comprises at least about 1 wt %, or at least about 3 wt %, or at least about 7 wt % metakaolin based on the total weight of the composition. Generally, the metakaolin is present in an amount less than 40 wt %, however, more typically, the metakaolin is present in an amount less than 20 wt % based on the total weight of the composition. In some aspects, the metakaolin is present in an amount less than 15 wt %, or less than 12 wt %, or less than 10 wt %, or less than 8 wt % based on the total weight of the composition. The aforementioned upper limits and lower limits may be in any combinations, for example from 1 wt % to 15 wt %, or from 1 wt % to 12 wt %, or from 1 wt % to 10 wt %, or from 1 wt % to 8 wt %, or from 3 wt % to 15 wt %, etc.

As indicated above, the flame-retardant polymer composition may optionally include a reinforcing additive. The terms “reinforcing additive” and “reinforcing material” are used interchangeably herein and refer to any material that can strengthen the polymer composition (e.g. improve the tensile and flexural modulus and/or tensile and flexural strength).

The reinforcing material or reinforcing additive may, for example, be wollastonite, talc, mica, hydrous kaolin, calcined kaolin, magnesium oxy sulfate, and/or reinforcing fibers. The reinforcing fibers may, for example, be glass fibers, carbon fibers, aramid fibers (e.g. Kevlar®, Nomex®, Technora®), wood fibers, basalt fibers or combinations of one or more thereof. In certain aspects, the reinforcing material is selected from glass fibers, wollastonite, talc, mica, carbon fibers or a combination thereof. In certain aspects, the reinforcing material is selected from glass fibers, carbon fibers or a combination thereof.

The hydrous kaolin or calcined kaolin reinforcing material typically will be ones having a shape factor (as described above) of above 20, and more typically of 60 or more. Additionally, talc, mica and wollastonite are also well-known high aspect ratio materials.

The reinforcing fibers may, for example, be wound into threads having a larger diameter than the fibers before incorporation in the flame-retardant polymer composition. The reinforcing fibers (e.g. glass fibers or carbon fiber filaments) may, for example, have a diameter ranging from about 6 μm to about 20 μm. For example, the reinforcing fibers (e.g. glass fibers) may have a diameter ranging from about 6 μm to about 19 μm or from about 6 μm to about 18 μm or from about 6 μm to about 17 μm or from about 6 μm to about 16 μm or from about 6 μm to about 15 μm or from about 6 μm to about 14 μm. For example, the reinforcing fibers (e.g. glass fibers) may have a diameter ranging from about 6.5 μm to about 13.5 μm or from about 7 μm to about 13 μm or from about 7.5 μm to about 12.5 μm or from about 8 μm to about 12 μm or from about 8.5 μm to about 11.5 μm or from about 9 μm to about 11 μm. The reinforcing fibers (e.g. glass fibers or carbon fiber filaments) may, for example, have a length ranging from about 3 mm to about 8 mm. For example, the reinforcing fibers (e.g. glass fibers) may have a length ranging from about 3 mm to about 5 mm or from about 3.5 mm to about 7.5 mm or from about 4 mm to about 7 mm or from about 4.5 mm to about 6.5 mm or from about 5 mm to about 6 mm.

Carbon fibers may, for example, be bundled such that each bundle comprises from about 1000 to about 100,000 carbon fiber filaments. For example, each bundle may comprise from about 2000 to about 80,000 or from about 3000 to about 50,000 or from about 4000 to about 25,000 or from about 5000 to about 20,000 carbon fiber filaments.

When present, the reinforcing material may, for example, be present in the flame-retardant polymer composition in an amount of at least about 1 wt % based on the total weight of the flame-retardant polymer composition. For example, the reinforcing material may be present in the flame-retardant polymer composition in an amount of at least about 5 wt %, or at least about 10 wt %, or at least about 12 wt %, or at least about 15 wt %, or at least about 18 wt %, or at least about 20 wt %, or at least about 22 wt %, or at least about 25 wt %, or at least about 28 wt % based on the total weight of the flame-retardant polymer composition.

When present, the reinforcing material may, for example, be present in the flame-retardant polymer composition in an amount up to about 50 wt % based on the total weight of the flame-retardant polymer composition. For example, the reinforcing material may be present in the flame-retardant polymer composition in an amount up to about 45 wt %, or up to about 40 wt %, or up to about 38 wt %, or up to about 36 wt %, or up to about 35 wt %, or up to about 34 wt %, or up to about 32 wt % based on the total weight of the flame-retardant polymer composition.

For example, the reinforcing material may be present in the flame-retardant polymer composition in an amount ranging from about 1 wt % to about 50 wt %, or from about 5 wt % to about 45 wt %, or from about 10 wt % to about 40 wt %, or from about 15 wt % to about 35 wt %, or from about 28 wt % to about 32 wt % based on the total weight of the flame-retardant polymer composition.

Generally, when a reinforcing additive is used, the combined amount of metakaolin and reinforcing additive in the composition will be up to 50 wt % based on the total weight of the flame-retardant polymer composition. For example, the combined amount of metakaolin and reinforcing additive can be up to 40 wt %, or up to 30 wt %, or up to 20 wt % based on the total weight of the flame-retardant polymer composition. Additionally, the combined amount of metakaolin and reinforcing additive will generally be at least 2 wt % based on the total weight of the flame-retardant polymer composition. More typically, the combined amount will be at least 11 wt %, or at least 13 wt %, or at least 15 wt % based on the total weight of the flame-retardant polymer composition. For example, the combined amount can be from 11 wt % to 50 wt %, or from 15 wt % to 40 wt %.

The flame-retardant polymer composition may, for example, comprise further additives. For example, the flame-retardant polymer composition may further comprise one or more of coupling agents (e.g. maleic anhydride grafted polyolefins), compatibilizers (e.g. maleic anhydride grafted polyolefins), opacifying agents, pigments, colorants, antioxidants, anti-fog agents, anti-static agents, moisture barrier additives, gas barrier additives, dispersants, hydrocarbon waxes, stabilizers, co-stabilizers, lubricants, agents to improve tenacity, agents to improve heat-and-form stability, agents to improve processing performance, process aids (for example Polybatch® AMF-705), mould release agents (e.g. fatty acids, zinc, calcium, magnesium, lithium salts of fatty acids, organic phosphate esters, stearic acid, zinc stearate, calcium stearate, magnesium stearate, lithium stearate, calcium oleate, zinc palmiate), antioxidants and plasticizers.

Each of the further additives may independently be present in the flame-retardant polymer composition. Each of the further additives may be present in the flame-retardant polymer composition in an amount ranging greater than 0 wt %, more typically at least 0.1 wt %, or at least 0.2 wt %, or at least 0.5 wt %, or at least 1 wt %, or at least 1.5 wt %, or at least 2 wt % based on the total weight of the flame-retardant polymer composition. The flame-retardant polymer composition may, for example, comprise no more than about 10 wt % or no more than about 5 wt % or no more than about 4 wt % or no more than about 3 wt % of further additives based on the total weight of the flame-retardant polymer composition.

Typically, mineral additives in flame-retardant polymer compositions result in a drop in the intrinsic viscosity number (as measured by ISO 307 standard) over flame-retardant compositions which are identical except that they do not comprise the mineral additives (“neat compositions”). However, it has been found that the use of metakaolin advantageously results in less of a drop in the intrinsic viscosity number than other mineral additives, for example hydrotalcite, mica, hydrous kaolin. Accordingly, the flame-retardant polymer composition with metakaolin can have an intrinsic viscosity number that is at least about 7 ml/g, or at least about 5 ml/g, or at least 4 ml/g, or at least 3 ml/g greater than the intrinsic viscosity number of a flame retardant-polymer composition which is identical except that it comprises a similar or same amount of a different mineral additive, for example hydrotalcite, wollastonite, mica, talc, hydrous kaolin, and/or calcined kaolin.

Further, the use of metakaolin can have an improved average MW (molecular weight as measured by gel-permeation chromatography). For example, the average MW can be similar to or higher than those for similar formulations that use hydrotalcite instead of metakaolin. The flame-retardant polymer compositions with metakaolin can have an average MW that is at least about 40%, or at least about 30%, or at least about 20%, or at least about 15%, or at least about 10%, or at least 5%, or at least 3% greater than the average MW of a flame-retardant polymer composition which is identical except that it does not contain metakaolin, or comprises a similar amount of a different mineral additive, for example hydrotalcite, wollastonite, mica, talc, hydrous kaolin, and/or calcined kaolin. While not wishing to be bound by theory, it is currently believed that the metakaolin slows down degradation of the resin/polymer during processing; thus, helping to maintain a higher MW. This also may help in resulting in a higher viscosity number.

Additionally, the flame-retardant polymer composition retains good mechanical properties. For example, the flame-retardant polymer composition can have a flexural modulus ranging from about 5000 MPa to about 15,000 MPa. Flexural modulus may, for example, be measured by ISO 178 (at 64 mm span and 2 mm/min speed). For example, the flame-retardant polymer composition may, for example, have a tensile modulus ranging from about 5000 MPa to about 16,000 MPa. Tensile modulus may, for example be measured by ISO 527 (Type 1A) (at 5 mm/min speed). For example, the flame-retardant polymer composition may, for example, have a tensile strength ranging from about 50 MPa to about 200 MPa. Tensile strength may, for example, be measured by ISO 527 (Type 1A) (at 5 mm/min speed). For example, the flame-retardant polymer composition may, for example, have a tensile elongation ranging from about 1% to about 15%. Tensile elongation may, for example, be measured by ISO 527 (Type 1A) (at 5 mm/min speed). For example, the flame-retardant polymer composition may have an ISO notched Izod impact ranging from about 3 kJ/m² to about 20 kJ/m². ISO notched Izod impact is measured by ISO 180 at 23° C. The flame-retardant polymer composition may have an ASTM notched Izod impact ranging from about 30 J/m² to about 200 J/m². ASTM notched Izod impact is measured by ASTM D256 at 23° C.

There is further provided herein articles made from or comprising a flame-retardant polymer composition according to any aspect or embodiment disclosed herein. The articles may comprise a substrate material and the flame-retardant polymer composition. For example, the substrate material can be made of the flame-retardant polymer composition, or optionally the substrate may be covered with the flame-retardant composition. For example, the flame-retardant polymer composition can be formed or deposited as a layer on at least a portion of the substrate material. The article may, for example, be a part for a car such as a car body part, a bumper, a door panel, a pipe, a dashboard, a wheel cover, an equipment housing, a display panel or an engine cover. For example, a metal pipe may be coated in the flame-retardant polymer composition, or metal bumper may be coated in the flame-retardant polymer composition. The article may, for example, be a cable (e.g. an electrical cable) covered with a flame-retardant polymer composition as disclosed herein. The article may be an electrical or electronic part. The article may, for example, be an electrical connector. The article may, for example, be a housing, for example, for an automotive and/or electronic application.

When the flame-retardant polymer composition is formed into a layer, for example, a layer on an article such as described herein, the flame-retardant polymer composition can have a flame-retardancy rating equal to or greater than V2 or V1 when measured using the United Laboratories Standard test 94, edition 6, (UL94). For example, the flame-retardant polymer composition may have a flame-retardancy rating equal to or greater than V0 when measured using the UL94 standard. The flame-retardancy ratings may, for example, be measured using compositions having a thickness of ⅛ inch (about 3 mm), 1/16 inch (about 1.5 mm) and/or 1/32 inch (about 0.8 mm).

The flame-retardant polymer composition may, for example, have a flame-retardancy rating of V0 when the flame-retardant polymer composition is formed into a layer having a thickness less than or equal to about %/8 inch (about 3 mm), and greater than or equal to about 1/128 inch (0.2 mm), the flame-retardant rating for the composition is V0 as determined by the United Laboratories Standard test 94, edition 6. For example, when the flame-retardant polymer is formed into a layer having a thickness of less than or equal to about 1/16 inch (1.5 mm) and greater than or equal to about 1/64 inch (0.4 mm), the flame-retardant rating for the composition is V0 as determined by the United Laboratories Standard test 94, edition 6. For example, when the flame-retardant polymer is formed into a layer having a thickness of less than or equal to about 1/32 inch (0.8 mm) and greater than or equal to about 1/64 inch, the flame-retardant rating for the composition is V0 as determined by the United Laboratories Standard test 94, edition 6.

The flame-retardant polymer composition may, for example, have a flame-retardancy rating of V0 when the flame-retardant polymer composition comprises equal to or greater than about 10 wt % flame retardant and equal to or greater than about 1 wt % metakaolin and when measured using the UL94 standard at a thickness of at least 1/64 inch (0.4 mm), and optionally equal to or less than ⅛ inch (3 mm), or equal to or less than 1/16 inch (1.5 mm), equal to or less than 1/32 (0.8 mm). The flame-retardant polymer composition may, for example, comprise from about 10 wt % to about 20 wt % flame retardant and from 1 wt % to 20 wt % metakaolin. Optionally, the polymer composition may, for example, comprise from about 10 wt % to about 40 wt % reinforcing material (e.g. glass fibers).

The flame-retardant polymer composition may, for example, have a flame-retardancy rating of V0 when the flame-retardant polymer composition comprises equal to or greater than about 12 wt % flame retardant and equal to or greater than about 5 wt % metakaolin and when measured using the UL94 standard at a thickness of at least 1/64 inch (0.4 mm), and optionally equal to or less than ⅛ inch (3 mm), or equal to or less than 1/16 inch (1.5 mm), equal to or less than 1/32 (0.8 mm). The flame-retardant polymer composition may, for example, comprise from about 12 wt % to about 18 wt % flame retardant and from about 5 wt % to about 15 wt % metakaolin. Optionally, the polymer composition may, for example, comprise from about 10 wt % to about 40 wt % reinforcing material (e.g. glass fibers).

The flame-retardant polymer composition may, for example, have a flame-retardancy rating of V0 when the flame-retardant polymer composition comprises equal to or greater than about 15 wt % flame retardant and equal to or greater than about 7 wt % metakaolin and when measured using the UL94 standard at a thickness of at least 1/64 inch (0.4 mm), and optionally equal to or less than ⅛ inch (3 mm), or equal to or less than 1/16 inch (1.5 mm), equal to or less than 1/32 (0.8 mm). The flame-retardant polymer composition may, for example, comprise from about 15 wt % to about 17.5 wt % flame retardant and from about 7 wt % to about 12 wt % metakaolin. Optionally, the polymer composition may, for example, comprise from about 10 wt % to about 40 wt % reinforcing material (e.g. glass fibers).

The flame-retardant polymer composition as disclosed herein typically will have a total flame time for the composition, when formed into a layer-such as on a substrate as described herein-having a thickness less than or equal to about 1/32 inch and greater than or equal to about 1/64 inch, of less than 50 seconds, or more typically less than 40 seconds, or less than 30 seconds, or for a thickness of about 1/64 inch, is less than 50 seconds, or more typically less than 40 seconds, as determined by the United Laboratories Standard test 94, edition 6.

The flame-retardant polymer composition may, for example, have a limiting oxygen index (LOI) ranging from about 24% to about 38%. For example, the flame-retardant polymer composition may have a LOI ranging from about 23% to about 37% or from about 24% to about 36% or from about 25% to about 35% or from about 26% to about 34% or from about 27% to about 34% or from about 28% to about 33%. Limiting oxygen index (LOI) may, for example, be measured by the ISO 4589 and/or ASTM D2863 tests.

The flame-retardant polymer composition may, for example, have a flame-retardancy rating that is equal to or greater than the flame-retardancy rating of a comparative composition that is identical except that it does not comprise the metakaolin. This may, for example, be measured by the UL94 standard.

The flame-retardant polymer composition may, for example, have a flame-retardancy rating that is equal to or greater than the flame-retardancy rating of a comparative composition that is identical except that it comprises a similar amount or the same amount of hydrous kaolin or calcined kaolin in place of the metakaolin.

Additionally, the current flame-retardant composition has improved corrosion resistance when compared of a comparative composition that is identical except that it does not comprise the metakaolin. Further, the flame-retardant polymer composition has improved corrosion resistance when compared to a comparative composition that is identical except that it comprises a similar amount or the same amount of hydrous kaolin, calcined kaolin, reinforcing additive or combinations thereof in place of the metakaolin. For example, when deposited on a substrate material to produce an article, as described herein, the substrate material having a layer of the current flame-retardant polymer composition will exhibit less corrosion over time than an identical substrate material having a layer of a flame-retardant polymer composition that is identical except comprising the same amount of a different mineral additive (for example hydrotalcite, wollastonite, mica, talc, hydrous kaolin, and/or calcined kaolin) than metakaolin.

There is further provided herein methods of making a flame-retardant polymer composition according to any aspect or embodiment disclosed herein. The methods may, for example, comprise mixing the polymer, the flame retardant, metakaolin and any optional additives.

The flame-retardant polymer compositions described herein may, for example, be made by compounding the polymer with the flame retardant, metakaolin, and any optional additives such as reinforcing material. Compounding per se is a technique which is well known to persons skilled in the art of polymer processing and manufacture and consists of preparing plastic formulations by mixing and/or blending polymers and optional additives in a molten state. It is understood in the art that compounding is distinct from blending or mixing processes conducted at temperatures below that at which the constituents become molten. Compounding may, for example, be used to form a masterbatch composition. Compounding may, for example, involve adding a masterbatch composition to a polymer to form a further polymer composition.

The flame-retardant polymer compositions described herein may, for example, be extruded. For example, compounding may be carried out using a screw, e.g. a twin screw, compounder, for example, a Baker Perkins 25 mm twin screw compounder. For example, compounding may be carried out using a multi-roll mill, for example a two-roll mill. For example, compounding may be carried out using a co-kneader or internal mixer. The methods disclosed herein may, for example, include compression moulding or injection moulding. The polymer and/or flame retardant and/or high aspect ratio particulate mineral and/or optional additives (e.g. reinforcing material) may be premixed and fed from a single hopper or independently fed from different hoppers into different zones of the extruder.

The resulting melt may, for example, be cooled, for example in a water bath, and then pelletized. The resulting melt may be calendared to form a sheet or film.

The flame-retardant polymer compositions described herein may, for example, be shaped into a desired form or article. Shaping of the flame-retardant polymer compositions may, for example, involve heating the composition to soften it. The polymer compositions described herein may, for example, be shaped by molding (e.g. compression molding, injection molding, stretch blow molding, injection blow molding, over molding), extrusion, casting, or thermoforming.

The foregoing broadly describes certain aspects and/or embodiments of the present invention without limitation. Variations and modifications as will be readily apparent to those skilled in the art are intended to be within the scope of the present invention as defined in and by the appended claims.

### EXAMPLES

### Example 1

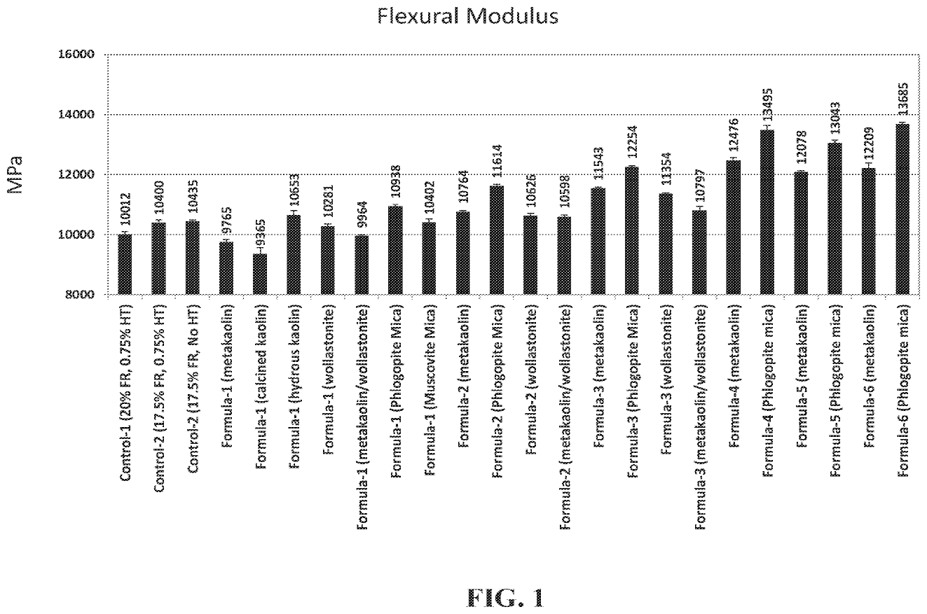

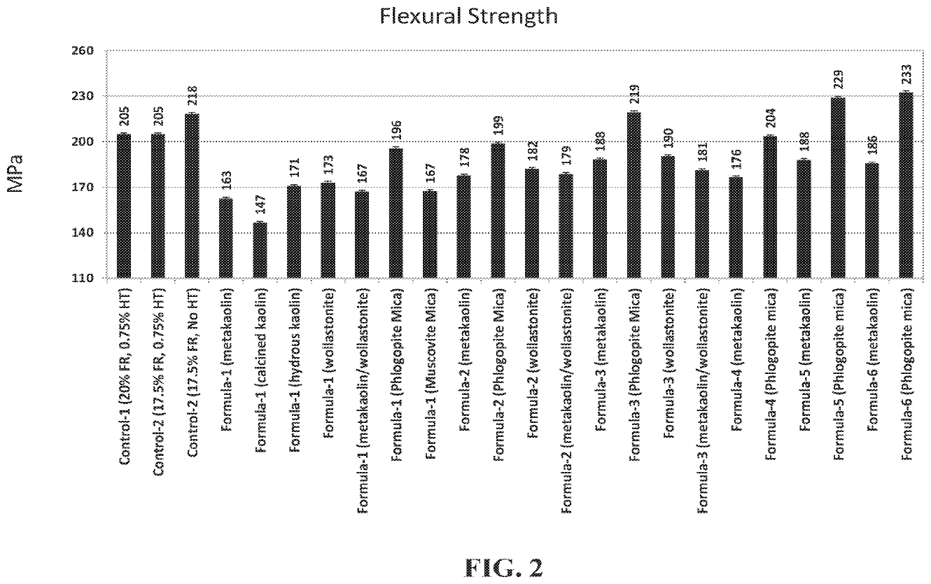

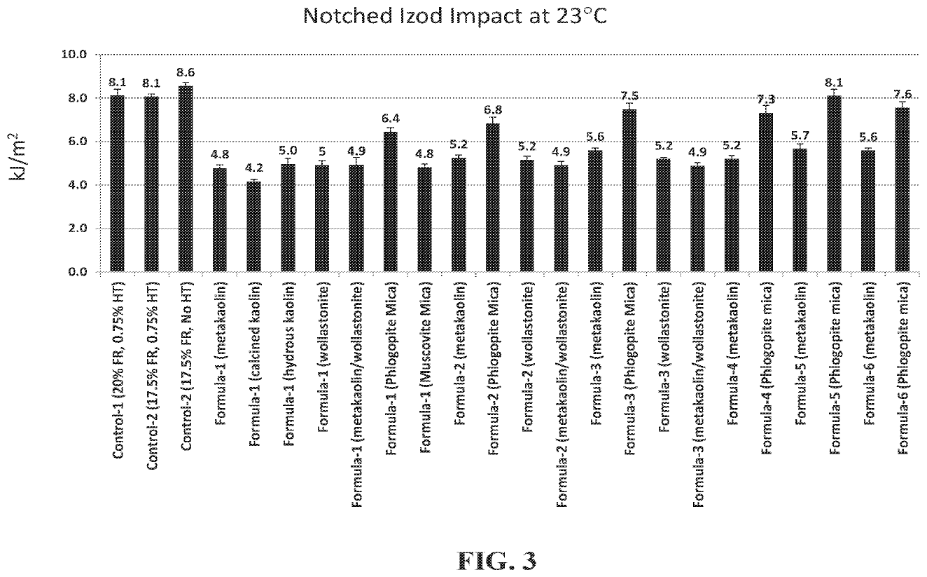

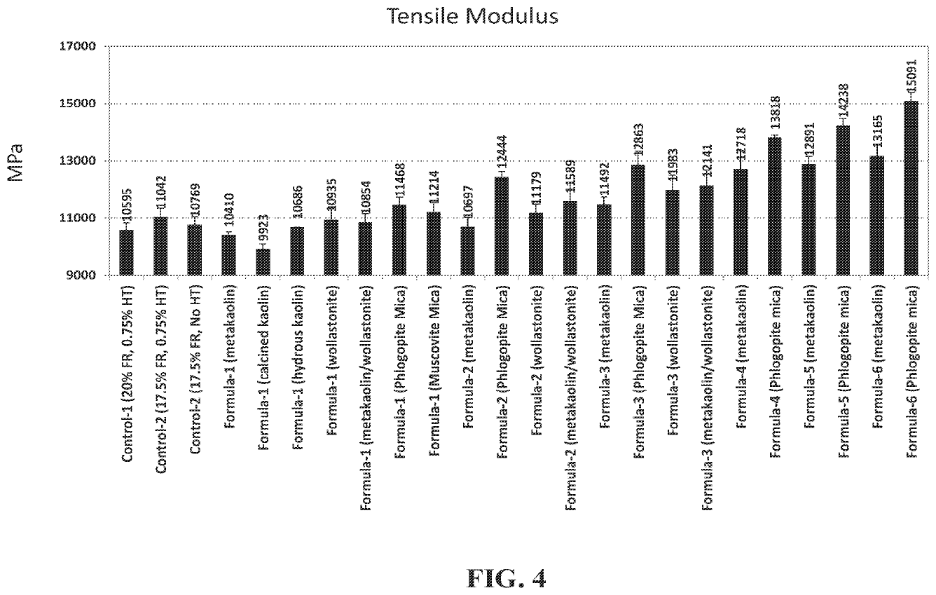

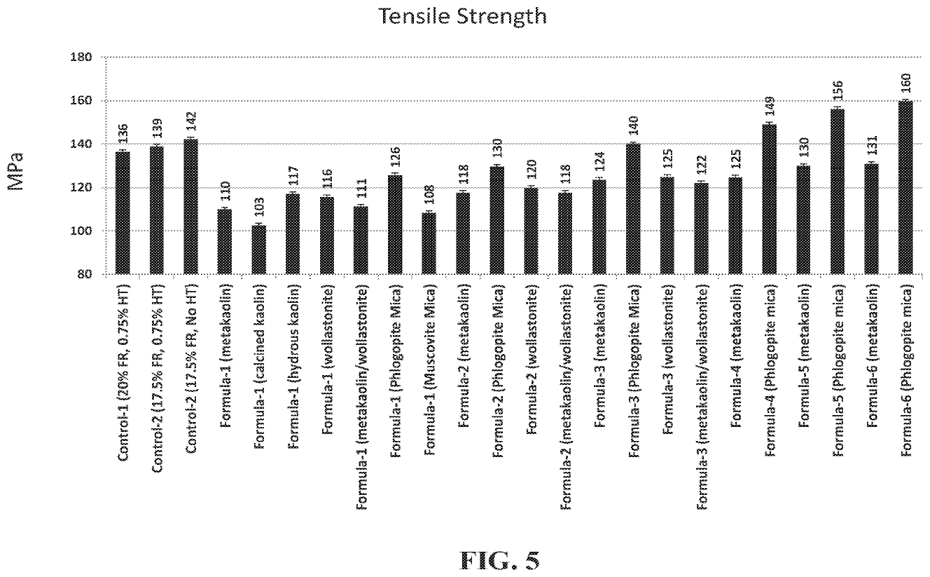

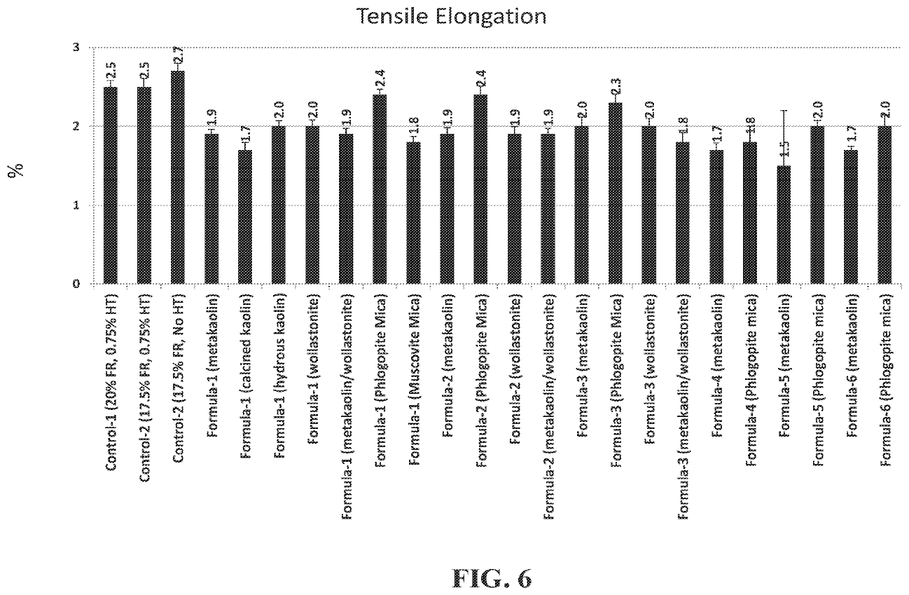

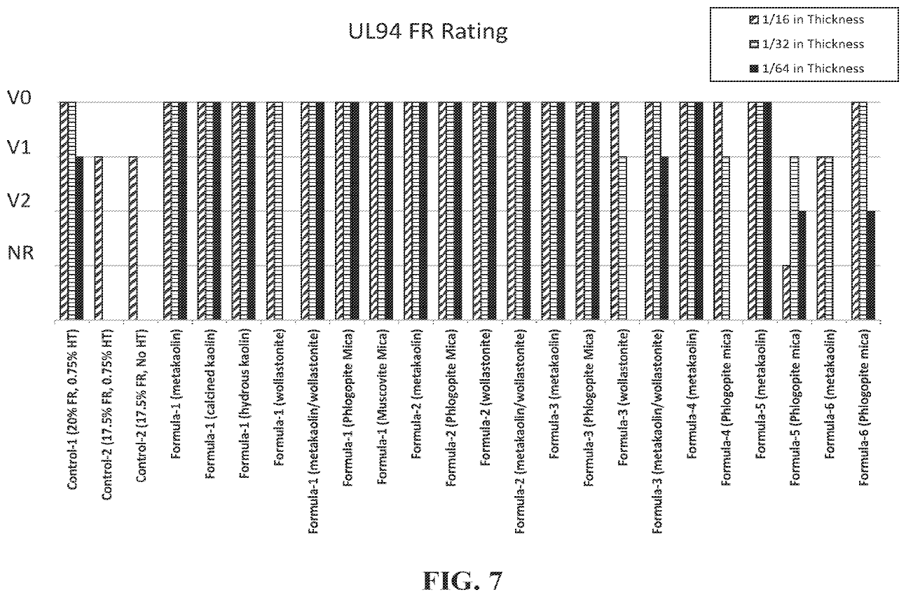

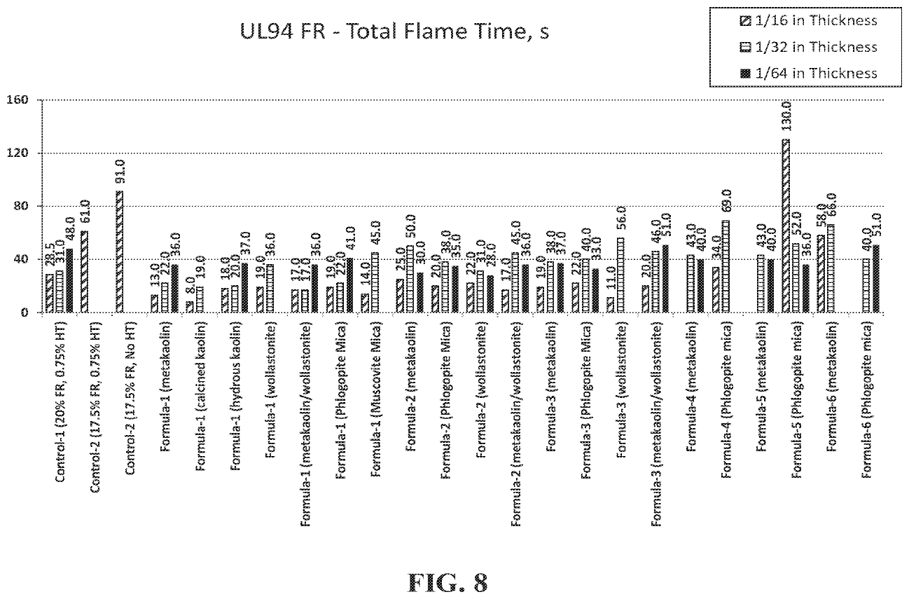

Various formulations as shown in Tables 1, 2, 3 and 4 were prepared and tested for physical properties. The results are shown in FIGS. 1-8. In the examples using metakaolin, the metakaolin had a shape factor of 8.7 and a soluble alumina content of 22.2%. For the data in FIG. 7, NR denotes a sample result which did not meet the V2 standard; in addition, the lack of a result in FIG. 7 means that testing at such thickness was not performed (such as when a thicker sample for the same formulation failed to meet the V0 standard).

TABLE 1

| | Control-1 | Control-2 | Control-2 | | Formula-1 | Formula-1 |
|---|---|---|---|---|---|---|
| | (20% FR, | (17.5% FR, | (17.5% FR, | Formula-1 | (calcined | (hydrous |
| Raw Material | 0.75% HT) | 0.75% HT) | No HT) | (metakaolin) | kaolin) | kaolin) |
| Ascend Nylon 6/6 | 49.05 | 51.55 | 52.30 | 49.05 | 49.05 | 49.05 |
| Organic | 20.00 | 17.50 | 17.50 | 17.50 | 17.50 | 17.50 |
| Phosphinate FR | | | | | | |
| additive | | | | | | |
| Hydrotalcite | 0.75 | 0.75 | 0 | 0.00 | 0.00 | 0.00 |
| Antioxidant | 0.20 | 0.20 | 0.20 | 0.2 | 0.2 | 0.2 |
| Johns Manvile | 30.00 | 30.00 | 30.00 | 25.75 | 25.75 | 25.75 |
| glass fiber sized | | | | | | |
| for nylon | | | | | | |
| Metakaolin with | | | | 7.50 | | |
| sedigraph d50 of | | | | | | |
| 1.0 micron | | | | | | |
| high aspect ratio | | | | | 7.50 | |
| hydrous kaolin | | | | | | |
| with sedigraph | | | | | | |
| d50 of 1.1 micron | | | | | | |
| Calcined kaolin | | | | | | 7.50 |
| with sedigraph | | | | | | |
| d50 of 0.7 micron | | | | | | |
| TOTAL (%) | 100.000 | 100.000 | 100.000 | 100.000 | 100.000 | 100.000 |

TABLE 2

| | | Formula-1 | Formula-1 | Formula-1 | | |
|---|---|---|---|---|---|---|
| | Formula-1 | (metakaolin/ | (Phlogopite | (Muscovite | Formula-2 | Formula-3 |
| Raw Material | (wollastonite) | wollastonite) | Mica) | Mica) | (metakaolin) | (metakaolin) |
| Ascend Nylon | 49.05 | 49.05 | 49.05 | 49.05 | 48.05 | 47.05 |
| 6/6 | | | | | | |
| Organic | 17.50 | 17.50 | 17.50 | 17.50 | 16.50 | 15.50 |
| Phosphinate FR | | | | | | |
| additive | | | | | | |
| Hydrotalcite | 0.00 | 0.00 | 0.00 | 0.00 | 0 | 0 |
| Antioxidant | 0.2 | 0.2 | 0.2 | 0.2 | 0.2 | 0.2 |
| Johns Manvile | 25.75 | 25.75 | 25.75 | 25.75 | 27.75 | 29.75 |
| glass fiber sized | | | | | | |
| for nylon | | | | | | |
| Metakaolin with | | 3.75 | | | 7.50 | 7.50 |
| sedigraph d50 of | | | | | | |
| 1.0 micron | | | | | | |
| High aspect ratio | 7.50 | 3.75 | | | | |
| wollastonite with | | | | | | |
| microtrac d50 of | | | | | | |
| 7 microns | | | | | | |
| High aspect ratio | | | 7.50 | | | |
| phlogopite mica | | | | | | |
| with sedigraph | | | | | | |
| d50 of 34 | | | | | | |
| microns | | | | | | |
| High aspect ratio | | | | 7.50 | | |
| Muscovite mica | | | | | | |
| with sedigraph | | | | | | |
| d50 of 17 | | | | | | |
| microns | | | | | | |
| TOTAL (%) | 100.000 | 100.000 | 100.000 | 100.000 | 100.000 | 100.000 |

TABLE 3

| | | | Formula-2 | Formula-3 | Formula-2 | Formula-3 |
|---|---|---|---|---|---|---|
| Raw | Formula-2 | Formula-3 | (Phlogopite | (Phlogopite | (metakaolin/ | (metakaolin/ |
| Material | (wollastonite) | (wollastonite) | Mica) | Mica) | wollastonite) | wollastonite) |
| Ascend | 48.05 | 47.05 | 48.05 | 47.05 | 48.05 | 47.05 |
| Nylon 6/6 | | | | | | |
| Organic | 16.50 | 15.50 | 16.50 | 15.50 | 16.50 | 15.50 |
| Phosphinate | | | | | | |
| FR additive | | | | | | |
| Hydrotalcite | 0 | 0 | 0 | 0 | 0 | 0 |
| Antioxidant | 0.2 | 0.2 | 0.2 | 0.2 | 0.2 | 0.2 |
| Johns | 27.75 | 29.75 | 27.75 | 29.75 | 27.75 | 29.75 |
| Manvile | | | | | | |
| glass fiber | | | | | | |
| sized for | | | | | | |
| nylon | | | | | | |
| Metakaolin | | | | | 3.75 | 3.75 |
| with | | | | | | |
| sedigraph | | | | | | |
| d50 of 1.0 | | | | | | |
| micron | | | | | | |
| High aspect | 7.50 | 7.50 | | | 3.75 | 3.75 |
| ratio | | | | | | |
| wollastonite | | | | | | |
| with | | | | | | |
| microtrac | | | | | | |
| d50 of 7 | | | | | | |
| micron | | | | | | |
| High aspect | | | 7.50 | 7.50 | | |
| ratio | | | | | | |
| phlogopite | | | | | | |
| mica with | | | | | | |
| sedigraph | | | | | | |
| d50 of 34 | | | | | | |
| micron | | | | | | |
| TOTAL | 100.000 | 100.000 | 100.000 | 100.000 | 100.000 | 100.000 |
| (%) | | | | | | |

TABLE 4

| | | Formula-4 | | Formula-5 | | Formula-6 |
|---|---|---|---|---|---|---|
| | Formula-4 | (Phlogopite | Formula-5 | (Phlogopite | Formula-6 | (Phlogopite |
| Raw Material | (metakaolin) | mica) | (metakaolin) | mica) | (metakaolin) | mica) |
| Ascend Nylon | 46.05 | 46.05 | 45.05 | 45.05 | 44.05 | 44.05 |
| 6/6 | | | | | | |
| Organic | 14.50 | 14.50 | 13.50 | 13.50 | 12.50 | 12.50 |
| Phosphinate FR | | | | | | |
| additive | | | | | | |
| Hydrotalcite | 0 | 0 | 0 | 0 | 0 | 0 |
| Antioxidant | 0.20 | 0.2 | 0.2 | 0.2 | 0.2 | 0.2 |
| Johns Manvile | 31.75 | 31.75 | 33.75 | 33.75 | 35.75 | 35.75 |
| glass fiber sized | | | | | | |
| for nylon | | | | | | |
| Metakaolin with | 7.5 | | 7.50 | | 7.50 | |
| sedigraph d50 of | | | | | | |
| 1.0 micron | | | | | | |
| high aspect ratio | | | | | | |
| hydrous kaolin | | | | | | |
| with sedigraph | | | | | | |
| d50 of 1.1 micron | | | | | | |
| Calcined kaolin | | | | | | |
| with sedigraph | | | | | | |
| d50 of 0.7 micron | | | | | | |
| High aspect ratio | | | | | | |
| wollastonite with | | | | | | |
| microtrac d50 of | | | | | | |
| 7 micron | | | | | | |
| High aspect ratio | | 7.50 | | 7.50 | | 7.50 |
| phlogopite mica | | | | | | |
| with sedigraph | | | | | | |
| d50 of 34 micron | | | | | | |
| High aspect ratio | | | | | | |
| Muscovite mica | | | | | | |
| with sedigraph | | | | | | |
| d50 of 17 micron | | | | | | |
| TOTAL (%) | 100.000 | 100.000 | 100.000 | 100.000 | 100.000 | 100.000 |

### Example 2

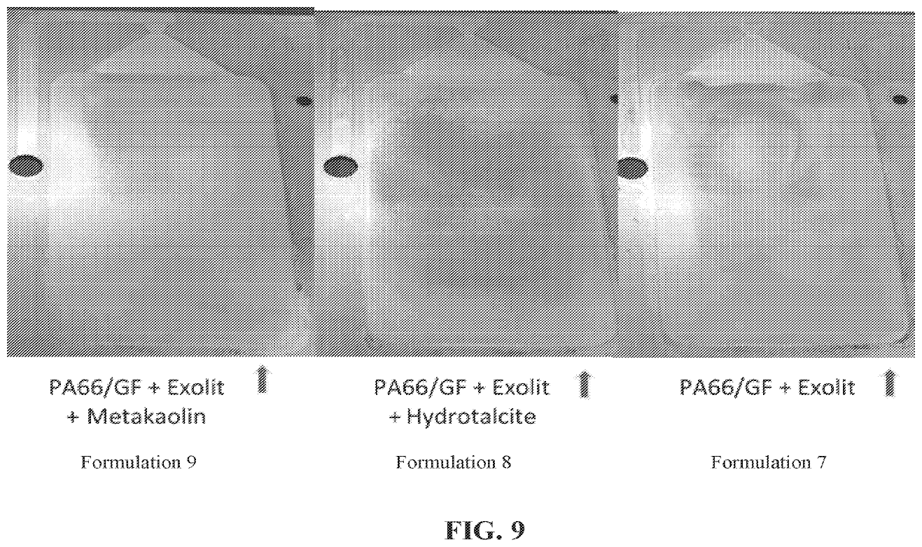

Corrosion Test: Various formulations as shown in Table 5 were prepared and tested for corrosion potential. The results are shown in FIG. 9. In the example using metakaolin, the metakaolin had a shape factor of 8.7 and a soluble alumina content of 22.2%.

A known challenge with using phosphinate based flame retardant additives such as Exolit product line from Clariant (including Exolit OP 1314 that has been used in this study) is their tendency to increase the corrosion potential of plastic compounds (including glass fiber filled polyamide 66 compounds used in this study) towards processing equipment including extruder screws, barrel, and other metal parts that come in contact with the molten resin. Exolit OP 1314 is a non-halogenated flame retardant based on organic phosphinates.

In order to evaluate and compare the corrosion potentials of different formulations used in this study, an internal test method was developed that simulates the high shear processing conditions that these formulations experience inside the plastic compounding extruders and injection molders. However, any such method or apparatus including a removable metal insert can be used.

The test uses a standard laboratory size injection molder (such as Arburg Allrounder 370E 600-170 that is used in this study) along with an especially designed mold which allows a removable metal insert to be installed in the mold cavity on the stationary side of the injection molding press. The mold set up allows the injection molding shots to be made directly on the removable metal inserts. The insert will come in contact with repeated number of injection molding shots (minimum of around 100 shots is required) before it is removed for corrosion inspection. The corrosion inspection is often qualitative as the number of shots that are made on the metal insert is limited, but could become quantitative for more corrosive material at larger number of shots. Quantitative analysis would be done using weight loss of the metal insert (after proper corrosion cleaning).

To compare the corrosion potential of different formulations used in this study, the injection molding conditions (operating parameters) used were kept constant for all formulations. Table 5 shows three different formulations that were used to evaluated the effect of metakaolin and hydrotalcite on the corrosivity of these formulations.

The “Control” Formulation 7 only contains Exolit Op 1314, PA66 resin and glass fiber. The other two formulations 8 and 9 contain either hydrotalcite or metakaolin as corrosion inhibitors. Hydrotalcite is commonly used at about 0.75 wt % loading in this type of application as an acid scavenger, which is the loading used in Formulation 8. A higher loading (7.5 wt %) of metakaolin was used (in Formulation 9) since it was desired/required for its function as a flame-retardant synergist in such formulations.

The visual comparison of the results in FIG. 9 shows that the Control Formulation 7 with no corrosion inhibitor has the deepest corrosion effect as is evident in the darker color at the top of the insert where it is first exposed to the molten plastic compound. The insert used with Formulation 8 containing hydrotalcite also shows significant corrosion, but the effect is spread out over a wider area. It does not show the deep/dark spots that are evident for the control sample. The best performance appears to be with Formulation 9 that contains metakaolin as both the spread of corroded area and the depth/darkness of corroded spots seem to be less significant.

TABLE 5
Table 5. Formulations used for the relative comparison of
corrosion potentials of Exolit based flame retardant PA66

| | Formulations (%) | | |
|---|---|---|---|
| | Formula- | Formula- | Formula- |
| Raw Material | tion 7 | tion 8 | tion 9 |
| Ascend Nylon 6/6 | 49.8 | 49.05 | 49.05 |
| Exolit OP 1314 (Clariant) - | 20 | 20 | 17.5 |
| phosphinate flame retardant | | | |
| Kisuma DHT-4A2 (Hydrotalcite) | 0 | 0.75 | 0 |
| Antioxidant (Irganox B1171 (BASF)) | 0.2 | 0.2 | 0.2 |
| Glass Fiber for PA66 TF | 30 | 30 | 25.75 |
| EC 10 - 675 (Johns Manville) | | | |
| Metakaolin - Polestar 450HP | 0 | 0 | 7.5 |
| (Imerys) | | | |
| TOTAL (%) | 100 | 100 | 100 |

FIG. 9 shows a clear reduction in the visual appearance of corrosion inserts in the injection molding tests showing the efficacy of metakaolin in reducing the corrosion potentials of PA66 formulation containing phosphinate flame retardants such as Exolit OP 1314.

Aspects of the present invention and/or disclosure are further illustrated by reference to the following, non-limiting numbered paragraphs describing exemplary embodiments.

1. A flame-retardant polymer composition comprising a polymer, a flame retardant, and metakaolin; wherein when the flame-retardant polymer is formed into a layer having a thickness less than or equal to about %/8 inch, and greater than or equal to about 1/128 inch, the flame-retardant rating for the composition is V0 as determined by the United Laboratories Standard test 94, edition 6.

2. The flame-retardant polymer composition of paragraph 1, wherein when the flame-retardant polymer is formed into a layer having a thickness of less than or equal to about 1/16 inch and greater than or equal to about 1/64 inch, the flame-retardant rating for the composition is V0 as determined by the United Laboratories Standard test 94, edition 6.

3. The flame-retardant polymer composition of paragraph 1, wherein when the flame-retardant polymer is formed into a layer having a thickness of less than or equal to about 1/32 inch and greater than or equal to about 1/64 inch, the flame-retardant rating for the composition is V0 as determined by the United Laboratories Standard test 94, edition 6.

4. The flame-retardant polymer composition of any of paragraphs 1-3, wherein the metakaolin has a shape factor of less than 20, and optionally no greater than 10, or no greater than 8, or no greater than 5.

5. The flame-retardant polymer composition of any of paragraphs 1-4, wherein the metakaolin has a soluble alumina content of from about 10 wt % to about 30 wt % by weight of the metakaolin, and optionally from about 14 to about 28 wt %, or about from about 18 wt % to about 26 wt %, or about 20 wt % to about 26 wt % by weight of the metakaolin. Optionally, the metakaolin has a soluble alumina content that is at least about 10 wt %, or at least about 12 wt %, or at least about 14 wt %, or at least about 18 wt %, or at least about 20 wt % by weight relative to the total weight of the metakaolin, and/or the soluble alumina content will be at most 30 wt %, or at most 28 wt %, or at most 26 wt %, or at most 24 wt % by weight relative to the total weight of the metakaolin.

6. The flame-retardant polymer composition of any of paragraphs 1-5, wherein the polymer is selected from polyalkylene (e.g. polyethylene, polypropylene or polybutylene), polyvinyl ester (general formula —[RCOOCHCH₂]—), polystyrene, polyvinyl chloride, polyvinyl acetate, polyvinyl alcohol, polyacrylonitrile, acrylonitrile butadiene styrene, polyamide, polylactic acid, polybutylene terephthalate, polyethylene terephthalate, polycarbonate, polyvinyl acetate (e.g. ethylene vinyl acetate or poly(meth methacrylate)), copolymers of two of the listed polymers, terpolymers of three of the listed polymers, or a combination of two or more thereof. Optionally, the polymer is a polyamide.

7. The flame-retardant polymer composition of any of paragraphs 1-6, wherein the flame retardant is an intumescent flame retardant.

8. The flame-retardant polymer composition of any of paragraphs 1-7, wherein the flame retardant is phosphorous and/or nitrogen-containing compounds; for example, red phosphorus, a phosphate, a polyphosphate (e.g. melamine polyphosphate), a phosphonate (e.g. dimethyl methylphosphonate (DMMP), a phosphinate (e.g. aluminium diethyl phosphinate), a halogenated organophosphate (e.g. tris(1,3-dichloro-2-propyi)phosphate, tetrakis(2-chlorethyl)dichloroisoentyldiphosphate), a phosphazene, a polyphosphazene, a triazine (e.g. melamine-cyanurate), an organophosphate (e.g. triphenyl phosphate (TPP), resorcinol bis(diphenylphosphate) (RDP), bisphenol A diphenyl phosphate (BADP), tricresyl phosphate (TCP)), or a combination of one or more thereof. Optionally, flame retardant is an organophosphate, an organic phosphinate, a halogenated organophosphate or a combination of one or more thereof. Optionally, the flame retardant is an organic phosphinate.

9. The flame-retardant polymer composition of any paragraphs 1-8, wherein the flame retardant is present in an amount greater than about 10 or 12 or 13 or 14 or 15 wt % and less than or equal to 20 or 18 or 17.5 or 16.5 or 16 wt % based on the total weight of the flame-retardant polymer composition.

10. The flame-retardant polymer composition of any of paragraphs 1-9, wherein the metakaolin is present in an amount of at least about 1 wt % or 3 wt % or 5 wt % or 7 wt %, and less than 40 wt %, or less than or equal to 20 wt % or 15 wt % or 12 wt % or 10 wt % or 8 wt % based on the total weight of the flame-retardant polymer composition.

11. The flame-retardant polymer composition of any of paragraphs 1-10, wherein the total flame time for the composition, when formed into a layer having a thickness less than or equal to about 1/32 inch and greater than or equal to about 1/64 inch, is less than 50 seconds, or optionally less than 40 seconds, or optionally less than 30 seconds, or for a thickness of about 1/64 inch is less than 50 seconds or optionally less than 40 seconds, as determined by the United Laboratories Standard test 94, edition 6.

12. The flame-retardant polymer composition of any of paragraphs 1-11, wherein the composition has an average molecular weight of at least 3%, or optionally, at least 5% or at least about 10% or at least about 15% or at least about 20% or at least about 30% or at least about 40%, greater than the average molecular weight of a flame-retardant polymer composition which is identical except comprising the same amount of a different mineral additive than metakaolin and/or a different reinforcing additive than metakaolin, for example hydrotalcite, wollastonite, mica, talc, hydrous kaolin, or calcined kaolin.

13. The flame-retardant polymer composition of any of paragraphs 1-12, wherein the composition has an intrinsic viscosity of at least 3 ml/g, or optionally at least 4 ml/g or at least about 5 ml/g or at least about 7 ml/g, greater than the intrinsic viscosity number of a flame retardant-polymer composition which is identical except comprising the same amount of a different mineral additive than metakaolin and/or a different mineral additive than metakaolin, for example hydrotalcite, wollastonite, mica, talc, hydrous kaolin, or calcined kaolin.

14. The flame-retardant polymer composition of any of paragraphs 1-13, wherein the flame-retardant polymer composition has improved corrosion resistance when compared to a flame-retardant polymer composition that is identical except comprising the same amount of a different mineral additive than metakaolin and/or a different mineral additive than metakaolin, for example hydrotalcite, wollastonite, mica, talc, hydrous kaolin, or calcined kaolin.

15. The flame-retardant polymer composition of any of paragraphs 1-14, further comprising a reinforcing additive present in an amount of from about 10 wt % to about 40 wt %. The reinforcing additive may, for example, be wollastonite, talc, mica, hydrous kaolin, calcined kaolin, magnesium oxy sulfate, and/or reinforcing fibers. The reinforcing fibers may, for example, be glass fibers, carbon fibers, aramid fibers (e.g. Kevlar®, Nomex®, Technora®), wood fibers, basalt fibers or combinations of one or more thereof.

6. The flame-retardant polymer composition of paragraph 15, wherein the combined amount of metakaolin and reinforcing additive in the composition is up to 20 wt %, or 30 wt %, or 40 wt % or 50 wt % based on the total weight of the composition.

17. The flame-retardant polymer composition of paragraph 15 or paragraph 16, wherein the reinforcing additive is selected from glass fibers, wollastonite, talc, mica, magnesium oxysulphate, carbon fiber, hydrous kaolin having a shape factor of more than 20 (or preferably of 60 or more), calcined kaolin, and combinations thereof.

18. An article comprising a substrate material and a flame-retardant polymer composition of any of paragraphs 1-17.

19. The article of paragraph 18, wherein the substrate material is an electric cable, or electrical or electronic part, or a car part and the substrate material is made of or covered with the flame-retardant polymer composition.

1. A flame-retardant polymer composition comprising:
a polymer;
a flame retardant; and
metakaolin;
wherein when the flame-retardant polymer is formed into a layer having a thickness less than or equal to about ⅛ inch, and greater than or equal to about 1/128 inch, the flame-retardant rating for the composition is V0 as determined by the United Laboratories Standard test 94, edition 6.

2. The flame-retardant polymer composition of claim 1, wherein when the flame-retardant polymer is formed into a layer having a thickness of less than or equal to about 1/16 inch and greater than or equal to about 1/64 inch, the flame-retardant rating for the composition is V0 as determined by the United Laboratories Standard test 94, edition 6.

3. The flame-retardant polymer composition of claim 1, wherein when the flame-retardant polymer is formed into a layer having a thickness of less than or equal to about 1/32 inch and greater than or equal to about 1/64 inch, the flame-retardant rating for the composition is V0 as determined by the United Laboratories Standard test 94, edition 6.

4. The flame-retardant polymer composition of claim 1, wherein the metakaolin has a shape factor of less than 20.

5. The flame-retardant polymer composition of claim 4, wherein the metakaolin has a soluble alumina content of from about 10 wt % to about 30 wt % by weight of the metakaolin.

6. The flame-retardant polymer composition of claim 1, wherein the polymer is a polyamide.

7. The flame-retardant polymer composition of claim 1, wherein the flame retardant is an intumescent flame retardant.

8. The flame-retardant polymer composition of claim 1, wherein the flame retardant is an organic phosphinate.

9. The flame-retardant polymer composition of claim 1, wherein the flame retardant is present in an amount greater than about 10 wt % and less than or equal to 20 wt % based on the total weight of the flame-retardant polymer composition.

10. The flame-retardant polymer composition of claim 1, wherein the metakaolin is present in an amount of at least about 1 wt % and less than or equal to 20 wt % based on the total weight of the flame-retardant polymer composition.

11. The flame-retardant polymer composition of claim 1, wherein the flame-retardant polymer composition has improved corrosion resistance when compared to a flame-retardant polymer composition that is identical except comprising the same amount of a different mineral additive than metakaolin.

12. The flame-retardant polymer composition of claim 1, further comprising a reinforcing additive present in an amount of from about 10 wt % to about 40 wt %.

13. The flame-retardant polymer composition of claim 12, wherein the combined amount of metakaolin and reinforcing additive in the composition is up to 50 wt % based on the total weight of the composition.

14. The flame-retardant polymer composition of claim 13, wherein the reinforcing additive is selected from glass fibers, wollastonite, talc, mica, magnesium oxysulphate, carbon fiber, hydrous kaolin having a shape factor of more than 20, calcined kaolin, and combinations thereof.

15. An article comprising a substrate material and a flame-retardant polymer composition, wherein the flame-retardant polymer composition comprises:
a polymer;
a flame retardant; and
metakaolin present in an amount from about 1 wt % to about 20 wt % based on the total weight of the flame-retardant polymer composition, wherein the metakaolin has a soluble alumina content of from about 10% to about 30% by weight of the metakaolin and has a shape factor of less than 20;
wherein when the flame-retardant polymer is formed into a layer having a thickness less than or equal to about ⅛ inch, and greater than or equal to about 1/128 inch, the flame-retardant rating for the composition is V0 as determined by the United Laboratories Standard test 94, edition 6,
wherein the flame-retardant polymer composition has improved corrosion resistance when compared to a flame-retardant polymer composition that is identical except comprising the same amount of a different mineral additive than metakaolin.

16. The article of claim 15, wherein the substrate material is an electric cable, electrical or electronic part, or a car part and the substrate material is made of or covered with the flame-retardant polymer composition

17. The article of claim 16, wherein the polymer is a polyamide.

18. The article of claim 17, wherein the flame retardant is an intumescent flame retardant comprised of organic phosphinate and is present in an amount greater than about 10 wt % and less than or equal to 20 wt % based on the total weight of the flame-retardant polymer composition.

19. The article of claim 18, wherein the flame-retardant polymer composition further comprises a reinforcing additive selected from glass fibers, wollastonite, talc, mica, magnesium oxysulphate, carbon fiber, hydrous kaolin having a shape factor of more than 20, calcined kaolin, and combinations thereof, and wherein the combined amount of metakaolin and reinforcing additive in the composition is up to 50 wt % based on the total weight of the composition.

20. A flame-retardant polymer composition comprising:
a polyamide;
an intumescent flame retardant which is an organic phosphinate present in an amount from about 12 wt % to about 18 wt % based on the total weight of the flame-retardant composition;
metakaolin present in an amount from about 5 wt % to about 10 wt % based on the total weight of the flame-retardant polymer composition, wherein the metakaolin has a soluble alumina content of from about 20% to about 26% by weight of the metakaolin and has a shape factor of no greater than 5; and
reinforcing additive selected from glass fibers, wollastonite, talc, mica, magnesium oxysulphate, carbon fiber, hydrous kaolin having a shape factor of more than 20, calcined kaolin, and combinations thereof, wherein the combined amount of metakaolin and reinforcing additive in the composition is up to 30 wt % based on the total weight of the composition;
wherein when the flame-retardant polymer is formed into a layer having a thickness less than or equal to about ⅛ inch, and greater than or equal to about 1/128 inch, the flame-retardant rating for the composition is V0 as determined by the United Laboratories Standard test 94, edition 6; and
wherein the flame-retardant polymer composition has improved corrosion resistance when compared to a flame-retardant polymer composition that is identical except comprising the same amount of a different mineral additive than metakaolin.
